(19) United States
(12) Patent Application Publication
(10) Pub. No.: US 2004/0190209 A1
(43) Pub. Date: Sep. 30, 2004

(54) Apparatus for providing ESD protection for MOS input devices having ultra-thin gate oxides

(75) Inventors: Phillip Czeslaw Jozwiak, Plainsboro, NJ (US); John Armer, Middlesex, NJ (US); Markus Paul Josef Mergens, Ravensburg (DE); Christian Cornelius Russ, Diedorf (DE)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/812,176

(22) Filed: Mar. 29, 2004

Related U.S. Application Data
(60) Provisional application No. 60/458,650, filed on Mar. 28, 2003.

(51) Int. Cl. H02H 9/00

(52) U.S. Cl. 361/56

(57) ABSTRACT

Apparatus for generating an additional voltage drop to reduce the dangerously high voltage drop across an ESD-sensitive ultra-thin gate oxide of a MOS input device. The apparatus are designed to minimally interfere with the circuit requirements for normal operation. Specifically, The MOS input device is coupled between a pad and the logic core circuitry of the IC. In one embodiment, a voltage-drop element, such as a resistive element, inductor, or pass-gate MOS device, is coupled between the source of the MOS input device and a voltage line. Alternatively, the voltage-drop element may be coupled to the bulk, gate, and/or drain of the MOS input device. In another embodiment, the voltage-drop device may be an active device, which pumps up the potential at least one of the source, bulk, or drain regions of the input device from the ESD clamp.

### CROSS REFERENCES

This patent application claims the benefit of U.S. Provisional Application, Ser. No. 60/458,650, filed Mar. 28, 2003, the contents of which are incorporated by reference herein.

### FIELD OF THE INVENTION

The present invention generally relates to the field of electrostatic discharge (ESD) protection circuitry, and more specifically to reducing the effective voltage across the gate oxide of a MOS input device.

### BACKGROUND OF THE INVENTION

The protection of ultra-thin gate oxide against ESD stress is a critical factor in obtaining high levels of ESD hardness in CMOS technologies. When a voltage applied to the gate oxide becomes too high, the gate oxide will break down. In particular, silicon dioxide (SiO₂), which is conventionally utilized as the gate insulator of a MOS device, will break down upon being subjected to excessive electric fields. One skilled in the art will recognize that a particular break down voltage of the gate oxide is associated with various design and manufacturing parameters, such as the thickness of the gate oxide, as well as various processing factors during fabrication of the MOS device. The pulse duration during ESD stress is typically in the order of 100 nanoseconds (ns). For gate oxides having a thickness greater than 5 nanometers (nm), the gate oxide may be exposed to higher voltage across an oxide before breakdown occurs. Typically, the maximum electric field is approximately 20 MV/cm before breakdown of the oxide occurs.

However, as downscaling of feature size in advance CMOS technologies continues, when the gate oxide is scaled down to approximately 5 nm or less in thickness, a quantum-mechanical tunneling effect has been observed. In this instance, the gate oxide may be exposed to an electric field in the range of 6-9 MV/cm (DC), which causes breakdown to occur. Specifically, electrons will pass through the gate oxide to the silicon below the oxide layer, thereby creating a tunneling current that can lead to excessive power dissipation. During breakdown, the gate oxide is quickly exposed to overheating, which may cause irreversible damaged. Such damage may occur in one or more regions formed directly beneath the gate oxide, such as directly between the gate electrode and the substrate (bulk), and/or between the gate region facing either the source or the drain region.

FIG. 1 depicts a graph 100 representing current/voltage (IV) characteristics of transient gate oxide breakdown and a conventional ESD protection device, as would be associated with prior art methods of ESD protection. In particular, FIG. 1 shows an example of a transient breakdown characteristic 110 of the gate oxide illustratively having a thickness of 2.2 nm, and the IV characteristics of an ESD device, such as a grounded-gate NMOS (GGNMOS) device, with a typical ESD pulse duration of 100 ns. Graph 100 comprises an abscissa 104 representing the voltage characteristic, a left ordinate 102 representing the current (amps) through the GGNMOS device, and a right ordinate 106 representing current (milliamps (mA) through the gate oxide (GOX).

Tunneling current begins to occur around 6V (112 of FIG. 1) and damage occurs at around 7V (114 of FIG. 1), such that line 116 represents the IV curve of the damaged gate oxide. Specifically, as voltage is illustratively applied to the gate of a CMOS transistor, at approximately 6 volts, current begins to tunnel to at least one of the conductors (e.g., source, drain, and/or bulk) formed beneath the gate oxide. Illustratively, at 7 volts, the gate oxide breaks down and the current passing through the gate oxide increases dramatically, thereby damaging the transistor.

Overlaid, to form a so-called “ESD Design Window”, is the IV characteristic 120 of a prior art ESD protection clamp (GGNMOS). A comparison of the ESD protection device with the breakdown characteristic of the ultra-thin gate oxide demonstrates that the voltage across the clamp quickly exceeds the initial tunneling voltage (˜6V) 1 12 and the breakdown voltage (˜7V) 114 of the gate oxide. As shown in FIG. 1, normally, the ESD protection device (clamp) has the capability to provide protection (i.e. limit the ESD voltage transient) for the IC circuitry (i.e., input buffer) up to approximately 9 volts before the clamp itself begins to break down. However, the gate oxide of the input buffer limits the effectiveness of the clamp, since the gate oxide breaks down at a voltage (6-7 volts), which is significantly less than the voltage capabilities of the clamp (e.g., 9 volts).

As discussed above, technology downscaling forces the oxide thickness to decrease. However, the IV-characteristics for clamping devices have not proportionally decreased because of certain physical limits, as conventionally known in the art. As the continued reduction of oxide thickness further reduces the breakdown to lower and lower values, the ESD protection device cannot efficiently protect the oxide. For example, the effectiveness becomes obvious in a reduced maximum ESD stress handling current (Imax 130 of FIG. 1), in contrast to the actual limit of the clamp as determined by its second breakdown trigger current I₂ 122. The consequence is very problematic, since the above mentioned physical limits will be reached very soon, and the oxide breakdown will occur before any ESD protection device can trigger and/or limit the voltage. Accordingly, the ESD protection clamp can no longer provide ESD protection for the functional circuitry (e.g., input buffer) of an IC.

### SUMMARY OF THE INVENTION

The present invention generally describes a method and apparatus for generating an additional voltage drop to reduce the dangerously high voltage drop across the ESD-sensitive ultra-thin gate oxide of the MOS input circuit. The method and apparatus are designed to minimally interfere with the circuit requirements for normal operation. In one embodiment, the present invention comprises an integrated circuit (IC) having functional core circuitry comprising an I/O pad coupled to a first node, for providing an electrical signal to the functional core circuitry of the IC, and a first voltage line for coupling to a first voltage source. A first electrostatic discharge (ESD) protection clamp is coupled between the first node and the first voltage line.

The functional core circuitry of the IC comprises an input device, wherein the input device comprises a first bulk region, a source, and drain region formed in the first bulk region and forming a channel in the first bulk region therebetween. The drain and source regions are respectively coupled to logic circuitry of the functional core circuitry and the first voltage line. A gate region is disposed over the channel and at least a portion of the drain and source regions, wherein a thin-oxide gate region is disposed therebetween the gate region and the channel and the at least a portion of the drain and source regions. Additionally, a resistive element is coupled between the source region and the first voltage line.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a graph representing current/voltage (IV) characteristics of transient gate oxide breakdown and a conventional protection device;

FIG. 2 depicts a graph representing IV-characteristics of transient gate oxide breakdown and a conventional protection device in accordance with the present invention;

FIG. 3 depicts a block diagram of a generic integrated circuit (IC) of the present invention using an exemplary simple inverter stage, merely as an example of representing an input device;

FIGS. 4A to 4F depict schematic diagrams of illustrative embodiments suitable for providing passive oxide protection in accordance with the present invention;

FIG. 5 depicts a graph representing input breakdown IV characteristic comparisons;

FIGS. 6A and 6B depict a first illustrative layout of an input device of the present invention in accordance with FIG. 4C;

FIG. 7 depicts an illustrative cross-section of an input device of the present invention in accordance with FIG. 4D;

FIG. 8 depicts a schematic diagram of a passively protected input device having a second MOS transistor in series with the input device;

FIG. 9 depicts a schematic diagram of a cascoded input device utilized to serve multiple I/O pads;

FIG. 10 depicts a cross-sectional view of an input device having an actively pumped substrate in accordance with a first embodiment of the invention; and

FIG. 11 depicts a schematic diagram of an input device having an actively pumped source in accordance with a second embodiment of the invention.

### DETAILED DESCRIPTION OF THE INVENTION

The present invention includes providing a voltage drop to an input device (e.g., input buffer) of a thin-oxide MOS type integrated circuit (IC) that is being protected by electrostatic discharge (ESD) circuitry, in order to reduce the dangerously high voltage drop across the ESD-sensitive ultra-thin gate oxide of the MOS input circuit. In one embodiment, one or more passive resistive or impedance producing elements are inserted into the input devices of the thin-oxide MOS-type IC. The passive resistive element induces a voltage drop across such element to increase the failure voltage at the IC pin (i.e., the circuitry associated with a pin of an IC), thereby allowing the ESD circuitry to operate at said higher pin failure voltages, and consequently higher current levels as well. In a second embodiment, coupling is provided between an ESD clamp or transfer circuit and the source and/or bulk region(s) to provide active pumping to source and/or bulk regions.

Various aspects of the invention for “passive” and “active” oxide protection are described below. “Passive protection” is defined herein as ways of “pushing out the failure level of input pins”. Such passive “voltage-drop” elements may be coupled to the source, drain, bulk, or gate of a MOS input device, depending on circuit design specifications and the area of the gate oxide that is most susceptible to breakdown. For example, if the thin-oxide area between the source and gate is more susceptible to breakdown, as opposed to the thin-oxide area between the gate and bulk, then a voltage drop element may be coupled to the source and/or the gate of the input device.

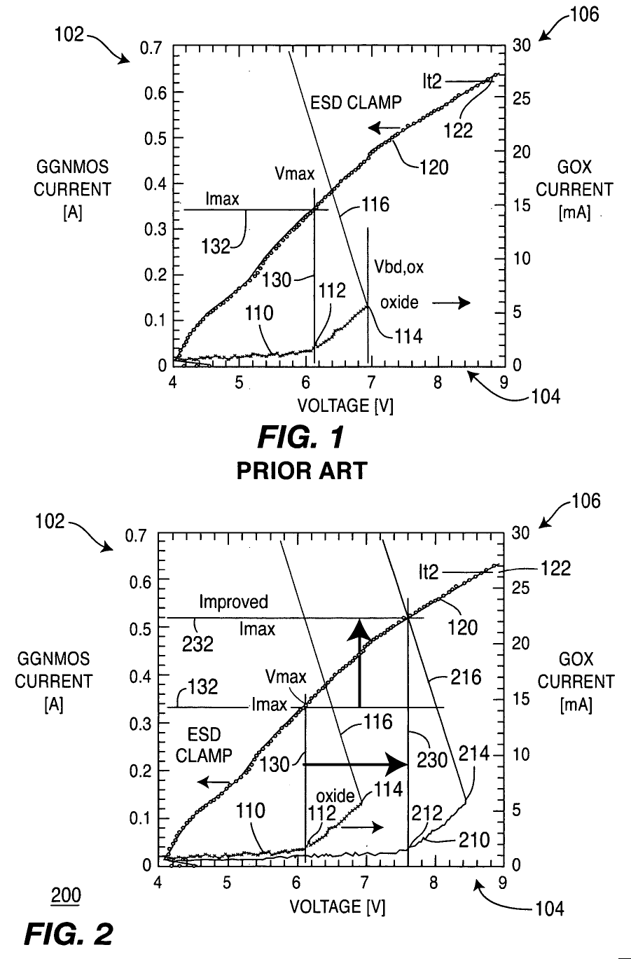

FIG. 2 depicts a graph representing current/voltage (IV) characteristics of transient gate oxide breakdown and a conventional protection device in accordance with the present invention. FIG. 2 is the same as FIG. 1, except that an additional curve 210 is shown, which represents extending the IV characteristics of the gate oxide input device in accordance with the principles of the present invention.

In particular, graph 200 comprises an abscissa 104 representing the voltage characteristic, a left ordinate 102 representing the current (amps) through the GGNMOS device, and a right ordinate 106 representing current (milliamps (mA) through the gate oxide (GOX). Curves 110 and 120 represent the IV characteristics for the gate oxide and GGNMOS device as would be associated with prior art methods of ESD protection and, as discussed above with respect to FIG. 1. It is noted that in this illustrative embodiment, the maximum voltage V_{MAX} and maximum current I_{MAX} that is allowed to pass through the gate oxide of the input device is approximately 6 volts (112) and 320 mA, respectively. Therefore, the GGNMOS device is only capable of clamping and ESD pulse up to a maximum of 6 volts.

By implementing passive resistive element(s) of the present invention into the input circuitry of the IC, the IV curve 110 is shifted to the right, as illustrated by curve 210. That is, if the total (breakdown) characteristic of the (unprotected) input stage can be “pushed out” to higher values, then the ESD Design Window can be extended to higher voltage and current levels, thereby, increasing the total ESD robustness of the input circuit.

As demonstrated in FIG. 2, the maximum ESD current is significantly increased for.which the voltage drop across the clamp reaches a critical value. In the example shown, almost the entire current capability of the protection device is reached. Specifically, the maximum voltage V_{MAX} and maximum current I_{MAX} that is allowed to pass through the gate oxide of the input device is increased to approximately 7.5 volts (112) and 520 mA, respectively. Thus, the GGNMOS clamp is able to provide greater ESD protection to the input device, without jeopardizing the gate oxide of the input device.

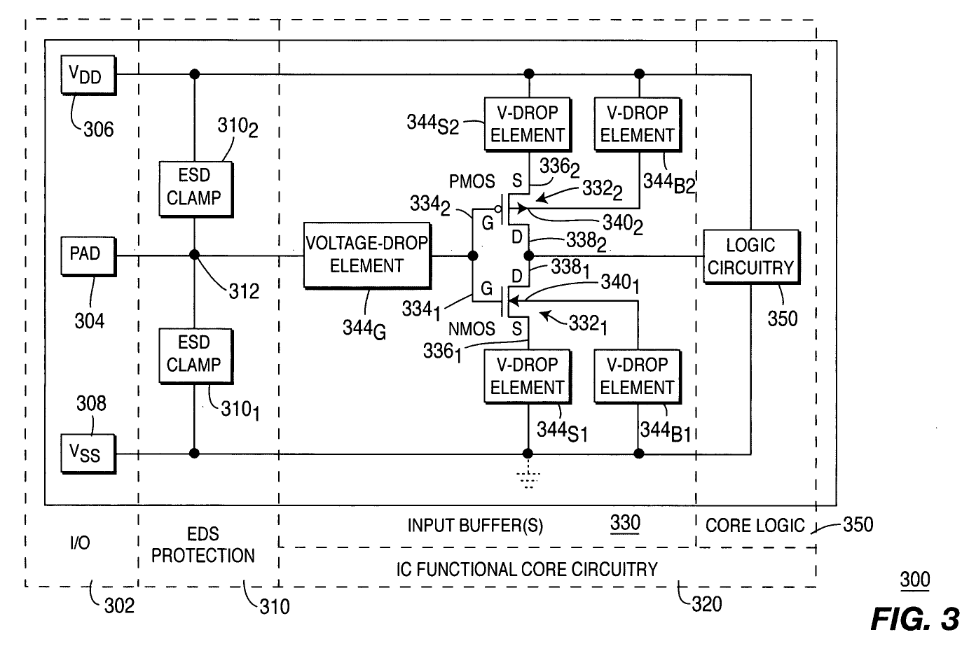

FIG. 3 depicts a block diagram of an integrated circuit (IC) 300 depicting an exemplary CMOS inverter stage comprising NMOS and PMOS transistors 332 to illustrate the principles of the present invention. While the exemplary inverter is illustrated in FIG. 3 as an input stage of the IC, one skilled in the art will appreciate that the input device may alternatively comprise one or more pass transistors having their respective gates tied to either a power line, or ground, or a control signal node, depending on the circuit specification. Accordingly, the inverter of FIG. 3 should not be considered as limiting the types of input devices, and the principles of the present invention are applicable to other types of input devices, such as pass-gate devices, amplifying devices, or any other MOS input device having a source, gate, and drain conductor.

Referring to FIG. 3, the IC 300 comprises a plurality of I/O pads 302, ESD protection circuitry 310, and functional core circuitry 320. Generally, the I/O pads 302 allow electrical input and output (I/O) signals to pass to and from the functional core circuitry 320 in a conventional manner known in the art. Moreover, the ESD protection circuitry 310 is utilized to protect the functional core circuitry 320 from undesirable electrostatic discharge events occurring at one or more of the I/O pads 302 in a conventional manner known in the art. Examples of protection devices that may be used as ESD clamps 310 hereto may be found in commonly assigned U.S. patent application Ser. No. 10/099,600, filed Mar. 15, 2002 (Attorney Docket No. SAR14176), which is incorporated by reference herein.

The functional core circuitry 320 comprises at least one input device 330 coupled between the I/O pad 304 and the logic circuitry 350 of the IC 300. The input device 330 is used as a first stage to distribute signals to the core logic 350. In one embodiment, the logic circuitry 350 may require I/O signals between an I/O pad 304 and VSS (ground) 308, as well as between the I/O pad 304 and a voltage source (e.g., VDD) 306. In this instance, an exemplary inverter may be used as an input device 330, where the I/O pad 304 is coupled to an NMOS transistor input device 332₁ and a PMOS transistor input device 332₂, which are both coupled to the logic circuitry 350.

In particular, the NMOS and PMOS transistors 332₁ and 332₂ each comprise a gate 334₁ and 334₂ (collectively gates 334), a source 336₁ and 3362 (collectively sources 336), a drain ³³⁸₁ and 338₂ (collectively drains 338), and a bulk region 340₁ and 340₂ (collectively bulk regions 340). In the embodiment shown in FIG. 3, the gate 334₁ of the NMOS transistor 332₁ is coupled to the pad 304 via a first node 312. Further, the source 336₁ of the NMOS transistor 332₁ is coupled to the grounded voltage line VSS 308, while the drain 338₁ of the NMOS transistor 332₁ is coupled to the logic circuitry 350. It is noted that the voltage line VSS may illustratively be coupled to ground (drawn in phantom in FIG. 3).

Additionally, the gate 334₂ of the PMOS transistor 332₂ is coupled to the pad 304 via a first node 312. Further, the source 336₂ of the PMOS transistor 332₂ is coupled to the voltage line VDD 306, while the drain 338₂ of the PMOS transistor 332₂ is coupled to the drain 338₁ of the NMOS transistor 332₁, such that the drains 338 are both coupled the logic circuitry 350.

ESD protection is provided by implementing an ESD clamp 310₁ illustratively between the first node 312 and ground 308 to protect the NMOS transistor input device 332₁ and logic circuitry 350, and an ESD clamp 310₂ between the first node 312 and the VDD voltage line 306 to protect the PMOS transistor input device 332₂ and logic circuitry 350. The ESD clamps 310 may be one or more serially coupled diodes, a silicon controlled rectifier (SCR), or any other clamping device capable of providing ESD protection for the functional core circuitry 320. Example of illustrative types of ESD protection devices suitable for use with the present invention are also discussed in detail in commonly assigned U.S. patent application ser. No. 10/099,600.

It is noted that in alternate embodiments, the logic circuitry 350 of the IC 300 may only require I/O signals as between the pad 304 and ground 308, or the pad 304 and a voltage potential, illustratively provided the voltage supply line VDD 306. Referring to FIG. 3, in an instance where the logic circuitry 350 transfers information between the I/O pad 304 and ground 308, then only the NMOS transistor 332₁ is utilized as the input buffer 330, and only ESD clamp 310₁ is coupled between the pad 304 and ground 308. Accordingly, voltage line VDD 306, the PMOS transistor 332₂, and the ESD clamp 310₂ are not utilized (i.e., coupled to the logic circuitry 350), and would not be shown in FIG. 3.

Conversely, in an instance where the logic circuitry 350 transfers information between the I/O pad 304 and VDD 306, then only the PMOS transistor 332₂ is utilized as the input device 330, and only ESD clamp 310₂ is coupled between the pad 304 and VDD 306. Accordingly, the VSS line (GND) 308, the NMOS transistor 332₁, and the ESD clamp 310₁ are not utilized (i.e., coupled to the logic circuitry 350) and would not be shown in FIG. 3.

As downscaling of feature size in advance CMOS technologies continues, when the gate oxide is scaled down to approximately 5 nanometers (nm) or less in thickness, a quantum-mechanical tunneling effect has been observed. In this instance, the gate oxide may be exposed to an electric field in the range of 6-9 MV/cm (DC), which causes breakdown to occur. As the continued reduction of oxide thickness further reduces the voltage levels at which breakdown occurs to lower and lower values, the ESD protection device cannot efficiently protect the oxide or the core logic circuitry, since the oxide breakdown will occur before any ESD protection device can trigger and/or limit the voltage. Accordingly, the ESD protection clamp can no longer provide ESD protection for the functional circuitry (e.g., input buffer) of an IC.

To overcome such detrimental effects to the gate oxides, as well as the significantly reduced ESD protection afforded by the ESD clamps, the present invention provides for the insertion of circuit elements 344 into the signal path at the gates 334 of the NMOS and PMOS, and/or into the bulk 340 and/or source paths 336 of the MOS devices. One or more of these circuit elements 344 are implemented to improve ESD protection for the core logic circuitry 320 with input devices 330 having thin-gate oxides of approximately five nanometers or less, as well as maintaining the normal (functional non-ESD) circuit operation specifications of the core logic circuitry 350. Furthermore, the inserted circuit elements 344 generate voltage drops during ESD events. In one embodiment, the inserted circuit elements 344 are passive elements devices, such as purely resistive elements, non-linear elements, or switched elements.

Referring to FIG. 3, five circuit elements (i.e., voltage drop elements) 344 are depicted. It is to be understood that each of the circuit elements 344 represents a different embodiment of the invention. For example, in a first embodiment where the logic circuitry 350 includes signal paths from the I/O pad 304 and both VDD 306 and VSS (ground) 308, then both ESD clamps 310₁ and 310₂ are respectively provided between the first node 312 and ground 308, and first node 312 and VDD 306. Furthermore, in one embodiment, a gate voltage-drop element 344_{G} is connected to the gates of both the NMOS and PMOS transistors 332₁ and 332₂ of the input devices 330 of the IC functional core circuitry 320.

In a second embodiment where the logic circuitry 350 utilizes just the I/O pad 304 and ground 308, then only the NMOS transistor 332₁ is coupled between the I/O pad 304 and the logic circuitry 350, as well as the ESD clamp 310₁ between the I/O pad 304 and VSS 308. Thus, the gate voltage-drop element 344_{G} serves to protect the thin-gate oxide of the NMOS transistor 332₁, as opposed to the gate oxide of the PMOS transistor 332₂ discussed above with respect to the first embodiment.

Similarly, in a third embodiment where the logic circuitry 350 utilizes just the I/O pad 304 and a voltage line having a potential (e.g., positive potential VDD) 306, then only the PMOS transistor 332₂ is coupled between the I/O pad 304 and the logic circuitry 350, as well as the ESD clamp 310₂ between the I/O pad 304 and VDD 306. Thus, the gate voltage-drop element 344_{G} serves to protect the thin-gate oxide of the PMOS transistor 332₂, as opposed to the gate oxide of the NMOS transistor 332₁ discussed above with respect to the first and second embodiments.

The three embodiments discussed above illustratively include a gate voltage-drop element 344_{G} to protect the thin-gate oxide of the input device. However, one skilled in the art will appreciate that a voltage-drop element may alternately be implemented in the source, bulk, or drain of an input device(s), or a combination thereof, depending on the region of the gate oxide that is most susceptible to damage. For example, if it is shown that the thin-gate oxide of an input device 330 is highly susceptible to damage proximate the source and bulk regions, then a source voltage-drop element 344ₛ and a bulk voltage-drop element 344_{B} may both be provided for the input device 330.

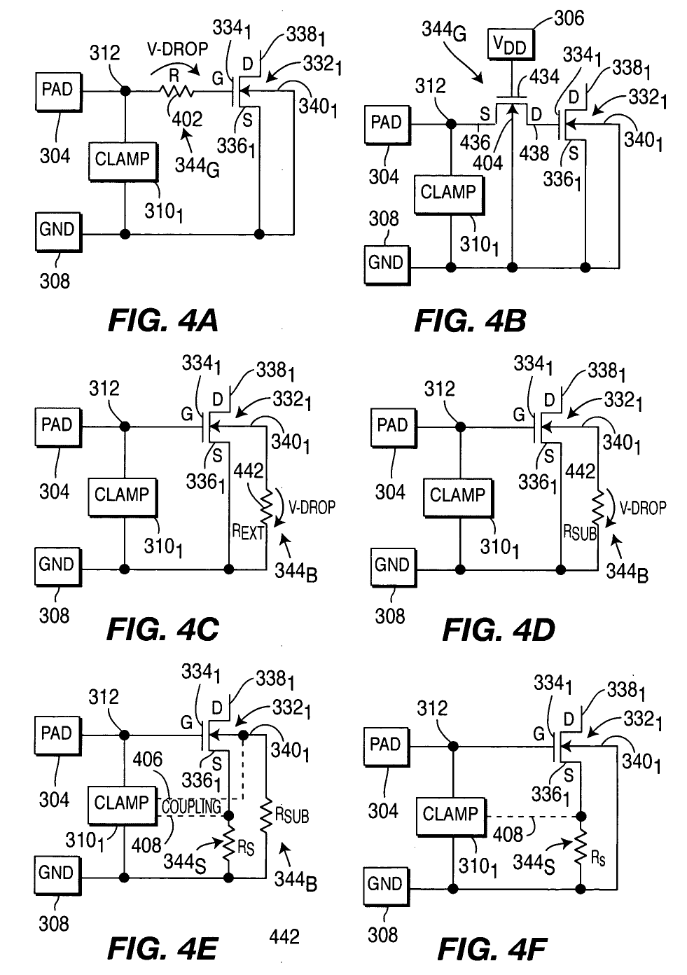

FIGS. 4A to 4F depict schematic diagrams of illustrative embodiments suitable for providing passive oxide protection in accordance with the present invention. In particular, each of the FIGS. 4A-4F represents an instance where the core logic 350 receives an input signal from the I/O pad 304 relative to ground (VSS). Accordingly, a single exemplary NMOS input device 330 is coupled between the first node 312 and the core logic 350. Further, although the invention is described herein with respect to NMOS transistors, such description is not intended in any way to limit the scope of the invention. Rather, a person skilled in the art will appreciate that the invention is also applicable with respect to PMOS devices.

In FIG. 4A, the voltage drop element 344_{G} comprises a pre-gate resistor R 402 having a resistance value of approximately one (1) kOhm or greater, and is provided before the gate terminal 334. The resistor 402 is coupled between the first node 312 and the gate 334 of the NMOS transistor 332. The bulk 340 and source 336 of the NMOS transistor 332 are coupled to VSS (ground) 308. The drain 338 of the NMOS transistor is coupled to the logic circuitry 350, as discussed above with respect to FIG. 3.

While allowing a small amount of tunneling current through the oxide, the resistor R 402 limits this tunneling current in the input stage, and builds up a voltage drop to allow a higher total ESD voltage occur at the pad 304. The higher the resistor value the better this effect will be. However, a drawback may occur during high-speed applications, such as RF applications, where such a resistor R may not be desirable because of undesirable RC effects.

In another illustrative embodiment shown in FIG. 4B, the resistor R 402 is replaced by a pass-gate transistor 404, while the remaining portion of the drawing is the same as in FIG. 4A. In FIG. 4B, an NMOS pass-gate transistor 332 is shown, however a PMOS transistor can additionally or alternatively be used. Specifically, the NMOS pass-gate transistor has a source 436 coupled to the first node 312, a drain 438 coupled to the gate 334₁ of the NMOS transistor input device 332₁, a gate 434 coupled to the voltage line VDD 306, and a bulk region (P-well) 440 coupled to VSS 308. During normal circuit mode of operation, VDD 306 is powered up to a positive potential. VDD turns on the pass-gate, thereby allowing the I/O signals to pass between the pad 304 and NMOS transistor input device 332₁ in a conventional manner.

During an ESD event, the VDD line 306 is not powered up, and VDD is either floating and/or capacitively coupled to VSS (ground) 308. The input NMOS 332 receives optimal protection as the voltage drop across the pass gate transistor 404 is large (e.g., up to the entire voltage as determined by the ESD clamp circuit) when the pass gate is off. Thus, the large voltage drop across the pass gate transistor 404 reduces the voltage at the gate terminal of the NMOS transistor input device 332, thereby protecting the thin-gate oxide of the NMOS transistor input device 332 from the effects of current tunneling.

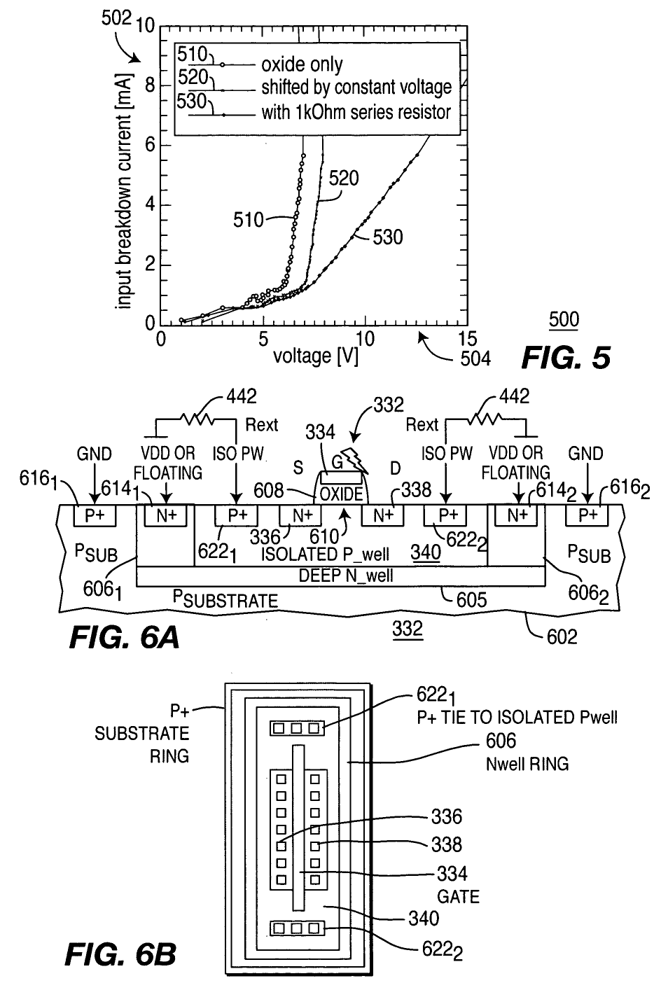

FIG. 5 depicts a graph 500 representing input current/voltage (IV) characteristic comparisons. The graph 500 comprises an ordinate 502 representing input breakdown current (mA), and an abscissa 504 representing voltage across the thin gate-oxide of the input device 332. Specifically, graph 500 includes curve 510 representing the input breakdown current of the gate oxide occurring around 6 to 7 volts, as discussed with respect to FIG. 1. Curves 520 and 530 respectively demonstrate that the input breakdown characteristics are improved by either shifting the IV-curve (curve 520) or by changing the slope of the curve (curve 530) in accordance with the invention.

For example, curve 520 is shifted to the right of curve 510, such that the input breakdown current of the thin-gate oxide occurs around 7 to 8 volts. Once the gate oxide breaks down, curve 520 drastically rises (e.g., almost 90 degrees straight up) from the abscissa 504, as the gate oxide fails. Curve 530 is also shifted to the right of curve 510, to around the same voltage of curve 520. However, instead of the input breakdown current steeply rising, as the gate oxide breaks down, the curve 530 rises at a much less rate, as illustrated by the 45 degree slope of curve 530 from the abscissa 504. Both effects are realized with the passive oxide protection of the present invention.

FIGS. 4C, 4D, 6A, 6B, and 7 depict examples of structures that allow passive oxide protection by lifting the substrate/bulk potential under the NMOS buffer. An isolated P-well or quasi-isolated P-well are introduced to increase the substrate potential under and around sensitive MOS devices.

Referring to FIG. 4C, in another embodiment of the present invention, a processing technology with a deep N-well (DNW) is used. FIG. 4C is the same as shown in FIGS. 4A and 4B, except that the voltage drop element 344_{G} is no longer connected between the first node 312 and the gate 334 of the NMOS transistor 332. Rather, the gate 334 of the NMOS transistor is coupled directly to the first node 312. The clamp 310 is again coupled from the first node 312 to ground 308. Further, the bulk 340 is coupled to ground via a voltage drop element 344_{B}, such as an external resistor Rext 442.

In one embodiment, the P-well (i.e. bulk) 340 of the NMOS transistor is completely isolated from the P-substrate (isolated P-well, ISO-PW). This allows the potential under the gate to be lifted up during short ESD events. As a result, an external (typically high Ohmic) resistor Rext 442, coupled from the bulk 340 to ground 308, generates a voltage drop if either a tunneling current flows through the substrate and/or a capacitive current flows during capacitive charging of the thin-gate oxide layer.

FIGS. 6A and 6B depict a first illustrative layout of an input device 332 of the present invention. In particular, FIGS. 6A and 6B respectively depict an exemplary side view and top view of the input device 332, and correspond to the a layout implementing a completely isolated P-well 340, in accordance with the schematic diagram of FIG. 4C. FIGS. 6A and 6B are illustrated and discussed as an NMOS transistor input device formed in a P-well (bulk) 340.

In particular, the input device 332 comprises a stack of doped layers that include a P-type substrate 602, a deep buried N-doped layer (hereinafter referred to as a “deep N-well”) 605, a P-well (bulk region) 340, a first high doped N+ region (source) 336, and a second high doped N+ region (drain) 338 formed in the P-well (bulk) 340 and defining a channel 610 therebetween the first and second N+ regions 336 and 338. A thin-gate oxide 608 is formed over the channel 610 and a portion of the first and second N+ regions 336 and 338, and a polysilicon gate region 334 is formed over the gate oxide 608. Accordingly, the input device NMOS transistor 332 is formed in the P-well by the first and second N+ regions 336 and 338, and the gate 334 formed over the channel 610 and portions of the source and drain regions 336 and 338.

On the silicon P-substrate 602, is formed the deep N-well 605. The deep N-well isolates the upper surface of the P-substrate 602 from the lower surface of the P-well 340. Lateral isolation of P-well 340 is provided by a lateral N-well ring 606. Specifically, deep highly N-doped regions (i.e., N-sinker region) 606₁ and 606₂ are formed adjacent between the P-substrate 602 and the sides of the P-well 340 by implanting N-type dopants having a doping concentration of about 10¹⁸ atoms/cm⁻³. The N-sinker regions 606₁ and 606₂ shown in FIG. 6A represent a ring 606 formed around the sides of the P-well 340, and the ring 606 extends a length substantially perpendicular to, and in contact with, the deep N-well 605. Accordingly, the P-well 340 is completely isolated from the P-substrate 602 by the deep N-well 605 and the lateral N-well ring 606.

It is noted that at least one P+ region 616₁ and 616₂ are disposed in the upper surface of the P-substrate 602 external to the inner portion of the lateral N-well ring 606. That is, the P+ regions 616 are formed external to the P-well 340. The P+ regions 616 are used to provide greater electrical conductivity to the P-substrate 602, and are coupled to ground 308. It is further noted that at least one N+ region 614₁ and 614₂ are disposed in the upper surface of the lateral N-sinker ring 606. That is, the N+ regions 614₁ and 614₂ are formed external to the P-well 340. The N+ regions 614 are used to provide greater electrical conductivity to the lateral ring 606, and are either left floating or are coupled to a supply line such as VDD 306. Further, at least one P+ tie region 622₁ and 622₂ are formed in the P-well 340 (internal to the lateral N-well ring 606) to provide greater conductivity for the P-well 340. The P+ regions 622 are coupled to ground 308 via one or more external resistors 442, thereby grounding the bulk region 340, as discussed above with respect to FIG. 4C.

An embodiment of a layout implementation of FIG. 6A is provided in FIG. 6B. FIG. 6B depicts a top view of an embodiment that illustrates how the different elements of a semiconductor structure can be placed area-efficiently. The lateral N-well ring 606 circumscribes the input device NMOS transistor 332 and the P+ ties 622. Note that in FIG. 6B, the P+ ties 622₁ and 622₂ are alternatively disposed in the isolated P-well 340 at the top and bottom of the structure in FIG. 6B, as opposed to being situated lateral to the source 336 and drain 338 of the NMOS transistor 332, as shown in FIG. 6A. The size and placement of the P+ ties 622 is not critical, since currents from the isolated P-well 340 to ground 308 are expected to be very small (i.e., with Rext 442 having a high resistance value, e.g., Rext>10 kOhm).

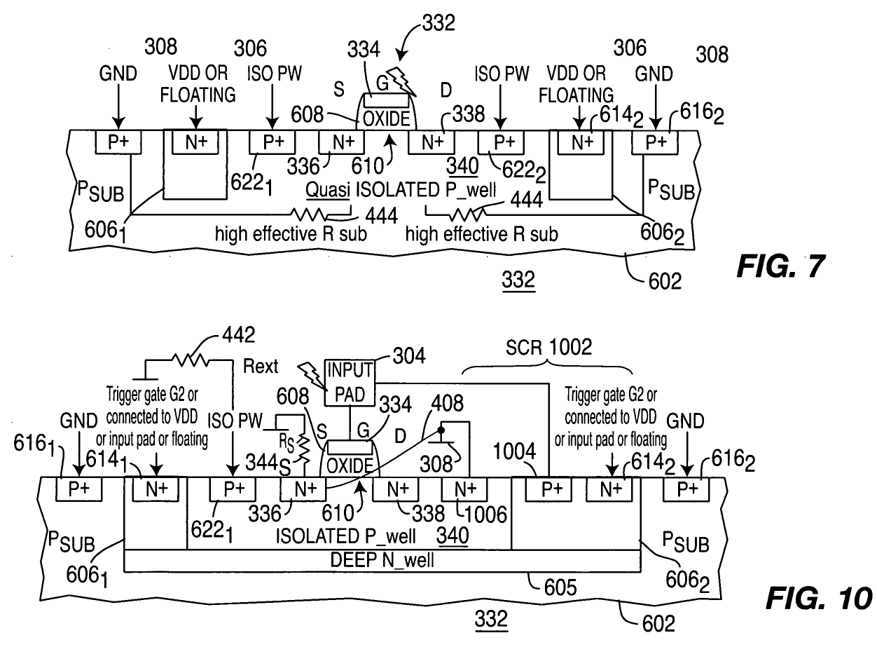

FIG. 7 depicts a second illustrative layout of an input device 332 of the present invention. Specifically, FIG. 7 represents a quasi-isolated P-well that is used in the absence of deep N-well (DNW) processing. The structure of FIG. 7 is the same as shown in FIG. 6, except that the deep N-well 605 is not present. However, the lateral N-well ring 606 encloses the sides of the P-well 340 of the NMOS transistor 332. Further, a schematic diagram of the quasi-isolated P-well 340 is represented by FIG. 4D. FIG. 4D is the same as FIG. 4C, except that the external resistor Rext 442 between the P-well 340 and ground 308 is replaced by a substrate resistance Rsub 444.

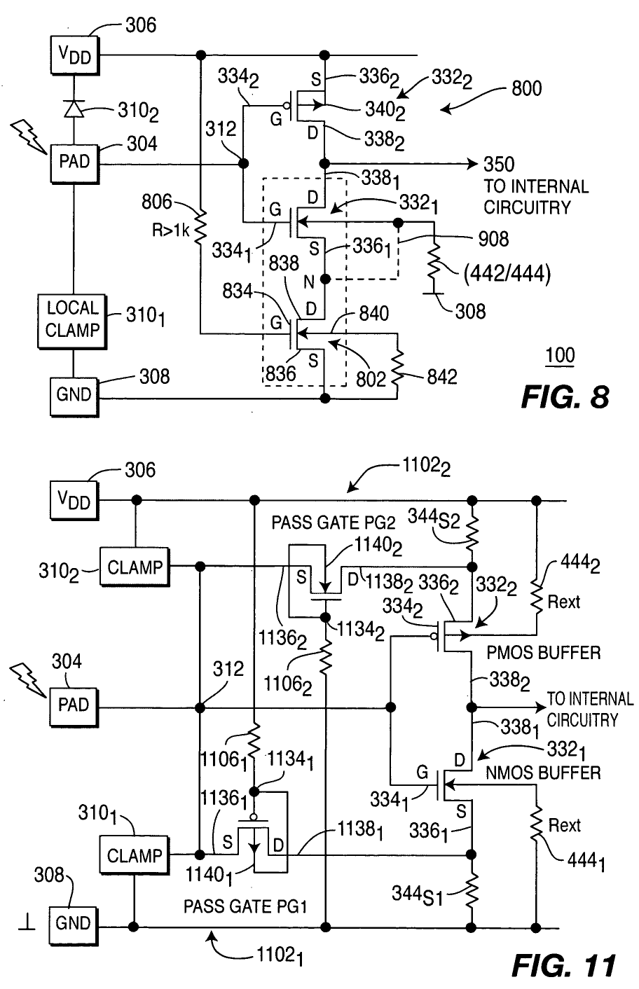

In particular, FIG. 7 illustrates a quasi-isolated P-well 340 in accordance with FIG. 4. The lateral N-well ring 606 locally shields the P-well 340 of the NMOS input device 332 from the main P-substrate 602. Isolating the P-well 340 from the P-substrate 602 induces a high effective substrate resistance Rsub 444. This embodiment of the invention is applicable to wafer processes without a deep N-well. The substrate potential is locally increased during an ESD event by a voltage drop across the high effective substrate resistance Rsub 444, or by injecting current from a substrate pump (discussed below with respect to FIGS. 4E and 8) into the terminals (P+ ties) 622 labeled ISO PW.

Thus, in one embodiment, the present invention has been discussed in terms of providing a voltage drop between the I/O pad 304 and the gate 334 of the input device 332. Specifically, a voltage drop element such as a resistive element (resistor) or a pass gate transistor (e.g., NMOS transistor) may be utilized. In a second embodiment of the present invention, a voltage drop element is provided between the bulk region 340 and ground 308. In this second embodiment, the voltage drop element my be an external resistor (Rext) 442 in the case where the bulk 340 is completely isolated from the P-substrate 602, or the intrinsic resistance (Rsub) 444 of the P-substrate 602 in case where the P-substrate 602 is quasi-isolated from the bulk 340 via a lateral ring 606. A third embodiment may be implemented by introducing a voltage-drop element (e.g., a resistive element such as an external resistor) between the source 336 and ground 308 of the input device 332.

FIG. 4F depicts a third embodiment of the present invention having a voltage-drop element 344ₛ located between the source 336 and ground 308 of the input device 332. FIG. 4C is the same as in FIGS. 4A and 4B, except that the voltage drop element 344_{G} is no longer connected between the first node 312 and the gate 334 of the NMOS transistor 332. Rather, the gate 334 of the NMOS transistor is coupled directly to the first node 312. The clamp 310 is again coupled from the first node 312 to ground 308. Further, the bulk 340 is coupled to ground either directly (as shown in FIG. 4C), or via a voltage drop element 344_{B}, such as an external resistor Rext 442 (not shown).

Referring to FIG. 6A, the layout of the input device is the same as discussed above with respect to FIG. 4B, however the voltage drop element Rₛ 344ₛ would be coupled from the source region 336 to ground 308. It is also noted that in an alternative embodiment, a second voltage drop element, such as a bulk area voltage drop element 334_{B} may be implemented in conjunction with the source voltage drop element 344ₛ.

FIG. 8 depicts a schematic diagram of a passively protected input device 800 having a second MOS transistor 804 in series with the input device 332. In the embodiment shown in FIG. 8, a second NMOS transistor 804 serves as the voltage-drop element 344ₛ, which is coupled in series to the NMOS transistor input device 332₁, thereby transforming the input device 332₁ from a single stage device to a cascoded buffer 802. It is noted that the insertion of a cascoded input stage 804 is not considered to compromise circuit performance during normal IC operation.

The exemplary input device 330 of the IC 100 comprises a PMOS transistor 332₂, a first NMOS transistor 332₁, and a second NMOS transistor 804. The source 336₂ of the PMOS transistor 332₂ is coupled to a voltage line VDD 306 having a positive potential, while the drain 338₂ of the PMOS transistor 332₂ is coupled to the internal functional circuitry 350, and the drain 338₁ of the first NMOS transistor 332₁. The source 336, of the NMOS transistor 332, is coupled to the drain 838 of the second NMOS transistor 804, while the source 836 of the second NMOS transistor 804 is coupled to ground 308.

The gates of the PMOS transistor 332₁ and first NMOS transistor 332₂ are coupled to the I/O pad 304 via first node 312. A first ESD clamp 310₁ is coupled from the first node 312 to ground (VSS) 308. A second ESD clamp 310₂ (e.g., diode) is also coupled from the first node 312 to VDD 306, such as by one or more serially coupled forward conducting diodes. The gate 834 of the second NMOS transistor 804 is connected to VDD 306. A resistor R 806 of typically greater than 1 kOhm is inserted between gate 834 and VDD 306 to protect the gate 834 of this newly introduced NMOS transistor 804. This resistor 806 protects the gate 834 of the second transistor 804 against ESD stress just in the same “passive” way as shown for the first NMOS buffer device 332₁ in FIG. 4A. This additional protection is needed in case of an ESD stress event between VDD 306 and GND 308. It is noted that P-wells of the first and second NMOS transistors 332₁ and 804 are quasi or completely isolated using the lateral ring/deep N-wells 606, and are coupled to ground 308 via resistors Rext (completely isolated) or Rsub (quasi-isolated), as discussed above with respect to FIGS. 6A and 7.

During normal circuit operation, the IC 100 is powered up, and the gate 834 of the second NMOS 804 is pulled high, thus turning the second NMOS 804 on. As a consequence the source 336₁ of the first NMOS 332₁ is coupled to ground 308 via the second NMOS 804. The second NMOS transistor 804 can be easily made large enough to have very little voltage drop between drain 838 and source 836, thus not causing any significant impact on the transmission characteristics and signal integrity, which are both important for high speed inputs.

During an ESD event, the IC 100 is not powered up. Thus, the VDD line 306 is (capacitively) coupled to ground 308. As a consequence, the second NMOS gate 834 is pulled low and the second NMOS 804 is turned off. Therefore, the source node N 336₁ of the first NMOS 332₁ is totally floating during an ESD event, and will largely reduce the gate to source voltage (Vgs) across the first NMOS transistor 332₁ during the ESD event. In one embodiment, the isolated P-well 340 of the first NMOS transistor 332₁ is connected to ground 308 via a high ohmic resistor Rext 442, as described above, to provide protection against stress between the gates and respective bulks. Again, as a measure to better protect the second NMOS 804 in case of ESD stress between VDD and GND, an isolated P-well may also grounded via a large external resistor 842 to GND.

In an alternative embodiment, the isolated P-well of the first NMOS 332₁ is connected (dashed line 908) directly to the source 336₁ of the same transistor 332₁. Thus, the isolated P-well 340₁ is floating, just as the source node 336₁ during and ESD event, and grounded during normal circuit operation. Accordingly, with respect to the embodiments of FIG. 3, the second NMOS transistor 804 serves as a voltage-drop element 344ₛ₁ for the source of the NMOS input device 332₁.

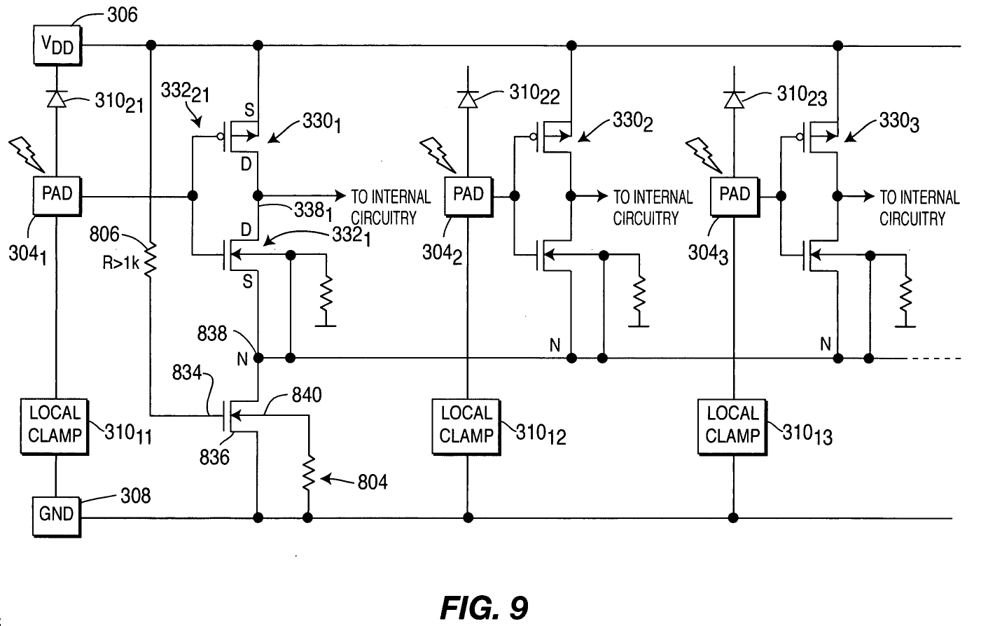

FIG. 9 depicts a schematic diagram of a cascoded input device 802 utilized to serve multiple I/O pads 304. In this instance, the second NMOS transistor 804 may be sized large enough (e.g. width>100μm) to serve multiple of input protection pads. One advantage of this embodiment is less silicon area consumption at each of the input devices.

In particular, a plurality of pads 304₁ through 304₃ is respectively coupled to the gates of input devices 330₁ through 330₃. Each of the input devices 330 is configured as shown and discussed above with respect to FIG. 8, where drain 338₂ of the PMOS 332₂ is coupled to the drain 338₁ of the first NMOS 332₁, which are coupled to the functional circuitry 350. The gates of the first NMOS and PMOS input devices 330 are coupled to a respective pad 304. For example, the gates 334 of PMOS transistor 332₂₁ and NMOS transistor 332₁₁ are coupled to pad 304₁, while the gates 334 of PMOS transistor 332₂₂ and NMOS transistor 332₁₂ are coupled to pad 304₂, and so forth.

Each gate of the input device 330 is respectfully coupled to VDD 306 via ESD protection devices 310₂, as well as to voltage line VSS (ground) 308 via ESD protection devices 310₁. For example, the gates of the first input device 330₁ are coupled to VDD 306 via clamp 310₂₁, as well as to ground 308 via claim 310₁₁. Further, the gates of the second input device 330₁₂ are coupled to VDD 306 via clamp 310₂₂, as well as to ground 308 via claim 310₁₂, and so forth.

Further, a single second NMOS transistor 804 has a drain 838 coupled to each source 336 of the first NMOS transistor 332₁ of each input device 330, and the source 836 coupled to ground 308. Accordingly, a single second NMOS transistor 804 is illustratively used as a voltage-drop element (i.e., voltage-drop element 344ₛ₁) for multiple input devices that are associated with respective I/O pads. It is noted that the gate 834 of the single second NMOS transistor 804 is coupled to VDD 306 via a resistor R 806 (e.g., where R>1 kOhm) as discussed above with respect to FIG. 8. It is further noted that although three I/O pads 304 and input devices 330 are illustratively shown, one skilled in the art will recognize that n I/O pads and associated buffers may be coupled to a single second NMOS transistor 804 to form a plurality of cascoded input devices, where n is an integer greater than one. However, the number n of I/O pads and associated buffers that may be coupled to a single second NMOS transistor 804 may be limited, due to size (width) constraints of the second NMOS transistor 804.

FIG. 10 depicts a cross-sectional view of an input device having an actively pumped substrate in accordance with a second embodiment of the invention. FIG. 10 is the same as the cross-sectional layout of FIG. 7, except that the lateral N-well ring 606 further comprises a P+ region 1004, and the P-well 340 further comprises an additional N+ region 1006. FIG. 10 should be viewed in conjunction with FIG. 4E, which depicts a schematic diagram of an input device utilizing an “actively pumped substrate” as a voltage drop element. FIG. 4E is the same as shown in FIG. 4D, except that source voltage drop 344ₛ is coupled from the source 336 of the input device 332 and ground 308, a first dashed line 406 is shown coupling the clamp 310 to the bulk 340, and a second dashed line 408 is shown coupling the clamp 310 to the source 336. FIG. 10 shows a cross-sectional layout of one embodiment of the actively pumped substrate input device.

In this embodiment, first coupling 406 is provided between the local ESD clamp 310 and the bulk 340, and is termed hereinafter as an “Actively Pumped Substrate.” Although the Actively Pumped Substrate is described with respect to this embodiment, one skilled in the art will appreciate that the Actively Pumped Substrate may be used with the other embodiments described herein. Furthermore, additional active coupling 408 is provided between the clamp 310 and the source region 306, hereby termed “Actively Pumped Source.” It is noted that the coupling 406 and 408 may be provided by using a resistive wire connection (FIG. 10) or any other resistive element (e.g., a pass-gate element 1102 as shown in FIG. 11).

As shown in FIGS. 4E and 4F, the exemplary resource for increasing the voltage potential (i.e., actively pumping) the source, bulk, and/or drain is the clamp (e.g., SCR) 310. Actively pumping the source, bulk, and/or substrate (bulk) helps reduce the voltage across the gate oxide. For example, actively pumping the source region increases the voltage potential of the source of the input device, thereby lowering the voltage difference between the gate and source of the input device. Accordingly, by lowering the voltage difference across the gate oxide (i.e., the gate region and the source region) helps reduce the likelihood of overheating the gate oxide, and the oxide damage associated with such overheating. A similar analysis is applicable to actively pumping the drain and bulk regions of an input device.

Referring to FIG. 10, the N+ region 1006, isolated P-well 340, lateral N-well 606, and P+ regions 1004 together form an SCR 1002. The N+ region 1006, isolated P-well 340, and lateral N-well 606 form an NPN transistor of the SCR 1002, while the P-well 340, lateral N-well 606, and P+ region 1004 form the PNP transistor of the SCR 1002, in a manner conventionally known in the art. In FIG. 10, it is noted that the P-well bulk 340 is illustratively coupled to ground via a bulk voltage drop element 344_{B}, such as an external resistor Rext, as discussed above with respect to FIGS. 4C and 4D.

Once the ESD clamp 310 triggers, the substrate potential around the clamp will increase (typically 0.7V to forward-bias e.g. the base-emitter junction of an NPN device or first gate (G1-Cathode) of an SCR device). This substrate potential is now coupled into the isolated P-well to increase the potential there to also approximately 0.7V and by this to decrease the voltage drop between the gate and bulk. Practically, the ESD clamp 310 and the NMOS input device 332 are directly situated in the same isolated P-well 340.

More specifically, this embodiment depicts coupling a (local) ESD clamp 310 with the gate oxide that needs to be protected. In particular, an SCR structure 1002 is shown illustratively as local ESD clamp 310, where the base of the NPN transistor is substantially identical to bulk 340 of the NMOS transistor 332, while both are located in the same isolated P-well 340. During an ESD event, the SCR clamp 310 triggers and increase the substrate potential to approximately 0.7 volts, and thereby reduce the voltage across the gate oxide. Additionally, a source resistance can be introduced in the source path of the NMOS or a cascoded NMOS, if used.

FIG. 11 depicts a schematic diagram of an input device having an actively pumped source in accordance with a second embodiment of the invention. Specifically, a PMOS transistor 332₂ and NMOS transistor 332₁ are serially coupled between voltage line VDD 306 and ground 308, as discussed above with respect to FIG. 8. Each of the bulk regions 340₁ and 340₂ of the MOS transistors 332₁ and 332₂ are completely isolated from the P-substrate 602, and are respectively coupled to ground 308 and VDD 306 via external resistances Rext 442. The gates 334₁ and 334₂ of the NMOS and PMOS transistors 332 are coupled to the first node 312, which is coupled to the I/O pad 304.

Referring to FIG. 4F, coupling 408 between each clamp 310 and source region 336 is illustratively provided using PMOS pass-gate transistors 1102, as shown in FIG. 11. As noted above, coupling may include any type of voltage drop element, such as an inductor, resistor, or pass gate transistor. Referring to FIG. 11, an exemplary PMOS pass-gate transistor 1102₁ has a drain 1038₁ coupled to the source region 336₁ of the NMOS transistor input device 332₁, a source 1136₁ coupled to the ESD clamp 310₁, and a gate 1134₁ coupled to voltage line VDD 306, via resistor (e.g., external resistor) 1106₁. Similarly, an NMOS pass-gate transistor 1102₂ has a drain 1138₂ coupled to the source region 336₂ of the PMOS transistor input device 332₂, a source 1136₂ coupled to the ESD clamp 310₂, and a gate 1134₂ coupled to ground 308, via resistor (e.g., external resistor) 1106₂.

Although not shown in FIG. 4F, in FIG. 11 a passive voltage drop element (e.g., Rext) 344_{B1} is coupled from the bulk 340₁ of the NMOS device 332₁ to VSS (ground) 308. Similarly, passive voltage drop element (e.g., Rext) 344_{B2} is coupled from the bulk 340₂ of the PMOS device 332₂ to VDD 306. Furthermore, and as shown in FIG. 4F, voltage drop element 344ₛ₁ is coupled 408 from the source 336₁ of the NMOS device 332₁ to VSS (ground) 308, such that the drain of the PMOS pass gate 1102₁ is coupled to source of the NMOS device 332₁. Similarly, voltage drop element 344_{S2} is coupled from the source 336₂ of the PMOS device 332₂ to VDD 306, such that the drain of the PMOS pass gate 1102₂ is coupled to source of the PMOS device 332₂. Thus, FIG. 11 illustratively includes the source resistors Rₛ and bulk resistors Rext, which passively pump the source and bulk regions, respectively. Additionally, the pass-gate transistors 1102 serve to actively pump the source regions by increasing the potential at the sources from the clamps.

More specifically, in FIG. 11, protection of the gate oxide of an input device 330 is provided by passively pumping the N-well (PMOS) and/or the P-well/Isolated-P-well (NMOS), as well as actively pumping the sources of the NMOS and PMOS input devices 332. In this case, the pass gate transistors 1102 are used to direct some of the ESD voltage into the source areas 336 of the NMOS and/or PMOS transistors 332₁ and 332₂ to pump the potentials. During normal circuit operation, the pass gate transistors 1102 are in off-state, and the source and bulk areas 336 and 340 of the input devices 332 are grounded (NMOS) or pulled to VDD (PMOS). However, during an ESD event, the pass gate devices 1102 are in an on-state.

In case of a “positive” ESD pulse at the pad 304, while the GND supply 308 of the IC 100 is connected to an external ground potential, the VDD line 306 is floating, and the positive ESD pulse will pass through the first pass-gate PG1 transistor 1102₁, where a negative gate-source voltage turns on the PMOS PG1 transistor 1102₁. The potential at the source 336₁ of the NMOS device 332₁ increases and the gate-source voltage is effectively reduced.

In case of a “negative” ESD pulse at the pad 304, while the VDD supply 306 of the IC 100 is connected to an external ground potential, the GND line 308 is floating, and the negative ESD pulse will pass through the NMOS pass-gate PG2 1102₂ (positive gate-source voltage turns on the NMOS of PG2). The potential in the source 336₂ of the PMOS device 332₂ decreases, and the absolute value of the gate-source voltage is effectively reduced.

It is noted that various passive or active techniques for providing oxide protection of the input device may implemented to produce a very effective total approach for oxide protection. For example, a resistive element may be provided before the gate terminal of the NMOS or PMOS input devices, or an isolated P-well with a high-ohmic resistor to ground may be utilized to reduce the effective gate-bulk oxide voltage (Vgb). Alternatively, a cascoded NMOS may be coupled in series with the NMOS input device to ground, in order to reduce the effective gate-source oxide voltage Vgs.

It is further noted that the embodiments shown and described herein are not considered as limiting. Although not specifically shown in the detailed drawings, the pass-gate transistors and resistive (voltage-drop) elements may be coupled to the drain regions 338 of the input devices 332 to induce a voltage drop at the drains of the input devices, in a similar manner as shown and discussed with respect to the gate, source, and bulk regions of the MOS transistor input devices.

Furthermore, one skilled in the art will appreciate that a PMOS input device may be coupled between the I/O pad 304 and ground 308, instead of the NMOS transistor as shown and discussed above. Similarly, the PMOS transistor input device utilized between the I/O pad 304 and VDD 306 may be instead an NMOS transistor input device. In any of these alternate embodiments, the implementation of passive and active elements as described herein is still applicable, and will result in the IV characteristics of the input device being shifted, as discussed with respect to FIGS. 2 and 5.

In addition, the actual oxide breakdown from gate to bulk or gate to source may respectively be different due to the actual electric field conditions in the MOS transistor. Therefore, each technology should be independently characterized (as illustratively shown by points 112 and 114 of the gate-oxide characteristics 110 of FIG. 1) with respect to breakdown voltages for both NMOS and PMOS devices under transient conditions, prior to deciding which of the suggested measures (i.e., passive/active voltage-drop elements) are most appropriate.

For example, when the gate-source breakdown voltage (Vgs) is higher than the gate-bulk breakdown, the voltage drop generation element may only be needed for the bulk. Or, if both voltages are low, the best implementation may be a pass-gate transistor in front of the gate covering both, Vgb and Vgs. In short, the choice of embodiments for a particular technology is made with respect to the gate-oxide characterization-set for that technology. There are several advantages provided by the present invention. First, a “vanishing” ESD Design Window poses a huge challenge. A conventional ESD clamping approach is not possible for input devices having thin-gate oxides, while the described method of “passive” oxide protection provides a viable solution by pushing out the actual possible voltage between an input node and a supply line (Vdd or GND).

Second, the ESD Design Window can be restored by reducing the oxide stress voltages for the input devices (both for Vgs and Vgb). Third, the implementation of the isolated P-well, pass-gate input, cascoded input device, and/or pass-gate bulk pump techniques described herein may be applied and/or modified to provide the extra protection mechanism, while not interfering with normal circuit operation.

While the foregoing is directed to the preferred embodiment of the present invention, other and further embodiments of the invention may be devised without departing from the basic scope thereof.

What is claimed is:

1. An integrated circuit (IC) having functional core circuitry, comprising:
an I/O pad coupled to a first node, for providing an electrical signal to said functional core circuitry of said IC, and a first voltage line for coupling to a first voltage source;
a first electrostatic discharge (ESD) protection clamp coupled between said first node and said first voltage line; and
wherein said functional core circuitry of said IC comprises an input device, said input device comprising: a first bulk region, a source, and a drain region formed in said first bulk region and forming a channel in said first bulk region therebetween, said drain and source regions respectively coupled to logic circuitry of said functional core circuitry and said first voltage line, a gate region disposed over said channel and at least a portion of said drain and source regions, and wherein a thin-oxide gate region is disposed therebetween said gate region and said channel and said at least a portion of said drain and source regions; and
a first resistive element coupled between said source region and said first voltage line.

2. The IC of claim 1, wherein said thin-oxide gate region has a thickness less than approximately five nanometers.

3. The IC of claim 1, wherein said input device comprises a first NMOS transistor.

4. The IC of claim 3, wherein said first voltage source is grounded.

5. The IC of claim 1, wherein said input device comprises a PMOS transistor.

6. The IC of claim 3, wherein said first voltage source has a positive potential.

7. The IC of claim 1 wherein said first resistive element comprises a resistor.

8. The IC of claim 1, wherein said resistive element comprises a MOS transistor coupled in series with said input device, said MOS transistor having a drain coupled to the source of said input device, a source for coupling to said first voltage line, and a gate for coupling to a second voltage line, said drain and source region of said MOS transistor formed in a second bulk region.

9. The IC of claim 8, wherein said gate of said MOS transistor is coupled to said second voltage line via a first resistor.

10. The IC of claim 9, wherein said first resistor has a resistance of at least 1 kohm.

11. The IC of claim 8, wherein said MOS transistor is coupled to a plurality of MOS transistor input devices respectively associated with a plurality of I/O pads, said MOS transistor having said drain coupled to each source of each of said plurality of MOS transistor input devices.

12. The IC of claim 8, wherein each of the bulk regions associated with said MOS transistors are disposed over a P-substrate, said bulk regions being at least partially isolated from said P-substrate.

13. The IC of claim 12, wherein a lateral N-well ring respectively circumscribes each bulk region, thereby partially isolating each bulk region from said P-substrate.

14. The IC of claim 13, wherein a deep N-well is respectively formed between each of said bulk regions and said P-substrate, thereby completely isolating each bulk region from said P-substrate.

15. The IC of claim 12, wherein each of said bulk regions is coupled to ground via respective second resistors.

16. The IC of claim 1, further comprising a second resistive element coupled between said first bulk region and said first voltage source.

17. The IC of claim 16, wherein said second resistive element comprises one of an inductor, a resistor, and a pass-gate transistor.

18. The IC of claim 1, further comprising a second resistive element coupled from said ESD protection clamp to said source of said input device.

19. The IC of claim 18, wherein said second resistive element comprises a pass-gate transistor having a source coupled to said ESD protection clamp, a drain coupled to said source of said input device, and a gate coupled to a potential differing from said first voltage line.

20. The IC of claim 19, further comprising a third resistive element coupled between said first bulk region and said first voltage source.

21. The IC of claim 1, further comprising a second resistive element coupled between said gate region of said input device and said first node.

22. The IC of claim 1, further comprising a second resistive element coupled between said drain region of said input device and a second voltage source.

23. An integrated circuit (IC) having functional core circuitry, comprising:
an I/O pad coupled to a first node, for providing an electrical signal to said functional core circuitry of said IC, and a first voltage line for coupling to a first voltage source;
a first electrostatic discharge (ESD) protection clamp coupled between said first node and said first voltage line; and
wherein said functional core circuitry of said IC comprises an input device, said input device comprising: a first bulk region, a source, and a drain region formed in said first bulk region and forming a channel in said first bulk region therebetween, said drain and source regions respectively coupled to logic circuitry of said functional core circuitry and said first voltage line, a gate region disposed over said channel and at least a portion of said drain and source regions, and wherein a thin-oxide gate region is disposed therebetween said gate region and said channel and said at least a portion of said drain and source regions; and
a first resistive element coupled between said first bulk region and said first voltage line.

24. The IC of claim 23, wherein said thin-oxide gate region has a thickness less than approximately five nanometers.

25. The IC of claim 23, wherein said input device comprises a first NMOS transistor.

26. The IC of claim 25, wherein said first voltage source is grounded.

27. The IC of claim 23, wherein said input device comprises a PMOS transistor.

28. The IC of claim 25, wherein said first voltage source has a positive potential.

29. The IC of claim 23, wherein said first resistive element comprises a resistor.

30. The IC of claim 25, further comprising a second input device, said second input device being a PMOS transistor comprising a second bulk region, a source and drain region formed in said second bulk region and forming a channel in said second bulk region therebetween, a gate coupled to the gate of said first NMOS transistor, a drain coupled to the drain of said first NMOS transistor, and a source coupled to a second voltage line for coupling to a second voltage source having a positive potential, said source of said PMOS device being coupled to said second voltage line, and said second bulk region coupled to ground via a second resistive element.

31. The IC of claim 30, wherein said second resistive element comprises a resistor.

32. The IC of claim 30, further comprising a second ESD protective clamp coupled between said first node and said second voltage line.

33. The IC of claim 30, wherein each of the bulk regions associated with said first and second NMOS transistors are disposed over a P-substrate, said bulk regions being at least partially isolated from said P-substrate.

34. The IC of claim 33, wherein a lateral N-well ring respectively circumscribes each bulk region, thereby partially isolating each bulk region from said P-substrate.

35. The IC of claim 34, wherein a deep N-well is respectively formed between each of said bulk regions and said P-substrate, thereby completely isolating each bulk region from said P-substrate.

36. An integrated circuit (IC) having functional core circuitry, comprising:
an I/O pad coupled to a first node, for providing an electrical signal to said functional core circuitry of said IC, and a first voltage line for coupling to a first voltage source;
a first electrostatic discharge (ESD) protection clamp coupled between said first node and said first voltage line; and
wherein said functional core circuitry of said IC comprises an input device, said input device comprising: a first bulk region, a source, and drain region formed in said first bulk region and forming a channel in said first bulk region therebetween, said drain and source regions respectively coupled to logic circuitry of said functional core circuitry and said first voltage line, a gate region disposed over said channel and at least a portion of said drain and source regions, and wherein a thin-oxide gate region is disposed therebetween said gate region and said channel and said at least a portion of said drain and source regions; and
a first resistive element coupled between said gate region and said first node.

37. An integrated circuit (IC) having functional core circuitry, comprising:
an I/O pad coupled to a first node, for providing an electrical signal to said functional core circuitry of said IC, and a first voltage line for coupling to a first voltage source;
a first electrostatic discharge (ESD) protection clamp coupled between said first node and said first voltage line; and
wherein said functional core circuitry of said IC comprises an input device, said input device comprising: a first bulk region, a source, and drain region formed in said first bulk region and forming a channel in said first bulk region therebetween, said drain and source regions respectively coupled to logic circuitry of said functional core circuitry and said first voltage line, a gate region disposed over said channel and at least a portion of said drain and source regions, and wherein a thin-oxide gate region is disposed therebetween said gate region and said channel and said at least a portion of said drain and source regions; and
a first resistive element coupled between said drain region and a second voltage source.
